(19) United States
(12) Patent Application Publication
(10) Pub. No.: US 2017/0259646 A1
(43) Pub. Date: Sep. 14, 2017

(54) AUTOMOBILE CLIMATE CONTROL SYSTEM AND METHOD

(71) Applicant: Louis Navarro, Astoria, NY (US)

(72) Inventor: Louis Navarro, Astoria, NY (US)

(21) Appl. No.: 15/069,850

(22) Filed: Mar. 14, 2016

(51) Int. Cl. B60H 1/32

(52) U.S. Cl. CPC B60H 1/3208; B60H 1/323; B60H 2001/3266; B60H 2001/327; B60H 2001/3292

(57) ABSTRACT

Disclosed is a system for controlling the climate within an automobile when the engine thereof is turned off. The system comprises an auxiliary AC compressor disposed in fluid communication with the pre-existing AC lines of the automobile, an engine sensor for detecting the current status of the engine, and an AC switch. The system is configured such that, the compressor is activated upon the switch being turned on and upon the engine being turned off.

### FIELD OF THE INVENTION

The present invention relates to utilities onboard automobiles and more particularly to a system and method for controlling climate with an automobile when the engine thereof is turned off.

Today, every automobile on the market comes equipped with an air-conditioning (AC) unit. An automobile AC unit is heavy-duty equipment in terms of its consumption of electricity. For instance, an automobile's onboard battery powering the AC unit easily runs out of its energy in a matter of just an hour's time. Due to this, a user cannot afford to leave the AC unit turned on (for the rest of the passengers in the automobile or to maintain the temperature within the automobile) when its engine turned off. As a result, especially in hot climatic conditions, the huge difference of temperature between air-conditioned interior and hotter exterior of the automobile sees a rapid rise of temperature in the interior of the automobile. This rapid escalation of temperature causes the passengers or the returning user a great discomfort. On the other hand, leaving the engine on for a prolonged period of time for maintaining the automobile temperature (through turning on the AC unit) consumes a substantial amount of fuel. Further, the need of having to maintain uniform temperature is quite long felt especially in emergency vehicles such as, ambulances, and the like.

In the light of what is discussed, there is a need in the art for a solution to the aforementioned problem.

### SUMMARY

An embodiment of the present invention comprises a system for controlling and maintaining the temperature within a turned-off automobile by activating an auxiliary AC compressor. The compressor is disposed in fluid communication with the onboard AC lines of the automobile. The system comprises an auxiliary battery, AC switch corresponding to the compressor and an engine sensor for detecting the current on/off status of the engine. A control module is designed to power up the compressor in response to a plurality of preset conditions being met. More particularly, the control module is configured to activate the compressor upon (1) the engine being turn off and upon (2) the AC switch being turned on. Conversely, the compressor is deactivated as soon as engine is turned on or when the AC switch is turned off. The system further comprises a precautionary fuse and relay units, which are designed to ensure safety in the event of an overload. The speed and temperature of the AC output is adjustable by onboard fan and temperature knobs respectively.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is a schematic illustration depicting the system.

FIG. 2, according to an embodiment of the present invention, is a flowchart depicting the method.

### FIGURES—REFERENCE NUMERALS

10—System
12—AC Compressor
14—Auxiliary Battery
16—Alternator
18—Fuse Unit
20—Relay Unit
22—Fan Knob
24—Temperature Knob
26—Power Motor

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

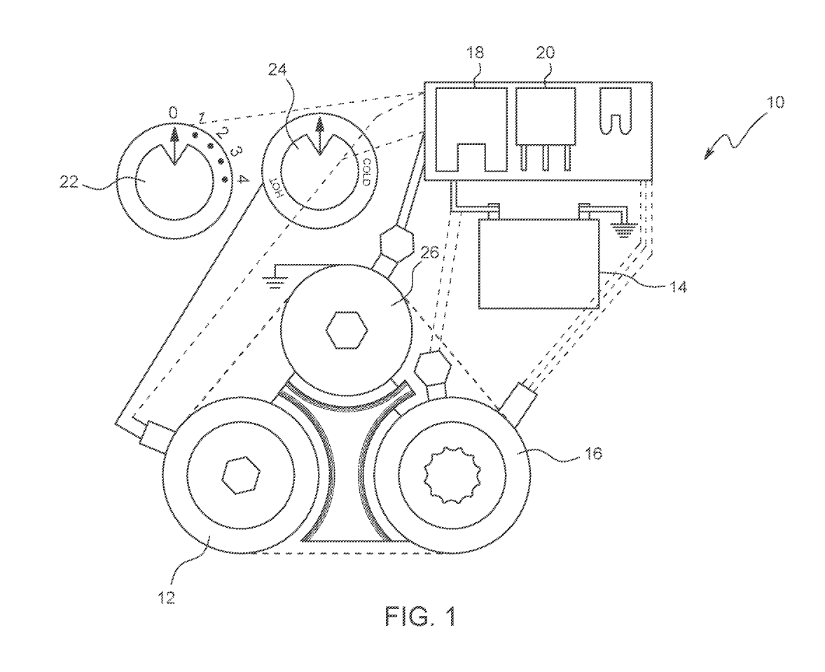

Referring to FIG. 1, an embodiment of the present invention comprises a system 10 for controlling and maintaining the climate (i.e., the temperature) within an automobile when the engine thereof is turned off. The system 10 comprises an auxiliary AC compressor 12, which is disposed in fluid communication with the high and low sides of the preexisting AC lines (not shown) onboard the automobile. The compressor 12 is adapted to be driven by a power motor 26, which is powered by an auxiliary battery 14 (in addition to the regular onboard battery). In one embodiment, this comprises an AC compressor. The battery 14, which preferably is a 12-volt battery, is in turn is charged by a preferably 200 amp alternator 16 when the automobile is back in motion. Notably, the battery 14 and the alternator 16 of any capacity is well within the scope of the present invention. The system 10 further comprises an AC switch (not shown), the utility of which will become apparent from the following body of text. Notably, the AC switch is located at a place within the automobile that is readily accessible by the user.

Referring to FIG. 1, the system 10 further comprises an engine sensor (not shown) for detecting whether the engine is currently turned on or off. The AC switch is disposed in electrical communication with the compressor 12 via a control module (not shown), which is designed to power up (or activate) the compressor 12 (by utilizing the battery 14 power) in response to a plurality of preset conditions being met. More particularly, the control module is configured to activate the compressor 12 upon (1) the engine being turned off as detected by the engine sensor and upon (2) the AC switch being turned on. Conversely, the compressor 12 is deactivated as soon as engine is turned on (as detected by the engine sensor) or the AC switch is turned off. The system 10 further comprises a precautionary fuse and relay units 18 and 20, which are designed to ensure safety in the event of an overload. The control module is further disposed in electrical communication with the onboard blower such that, the blower is activated upon the activation of the compressor 12. The system 10 is configured such that, the onboard fan and temperature knobs 22 and 24 are operable for adjusting the blower speed and the temperature respectively. In one embodiment, the system further comprises a cabin fan for circulating the output emanating from the blower.

In one embodiment, the power motor 26 is, in lieu of the compressor 12, disposed in operational communication with a plurality of utility devices onboard the automobile, which include a power steering pump, a water pump, a cooling fan, and a generator. Similar to the activation of the compressor 12, the utility devices are also configured to be activated upon the aforementioned preset conditions being met. This embodiment of the present invention is especially useful for emergency vehicles, such as, ambulances, and the like.

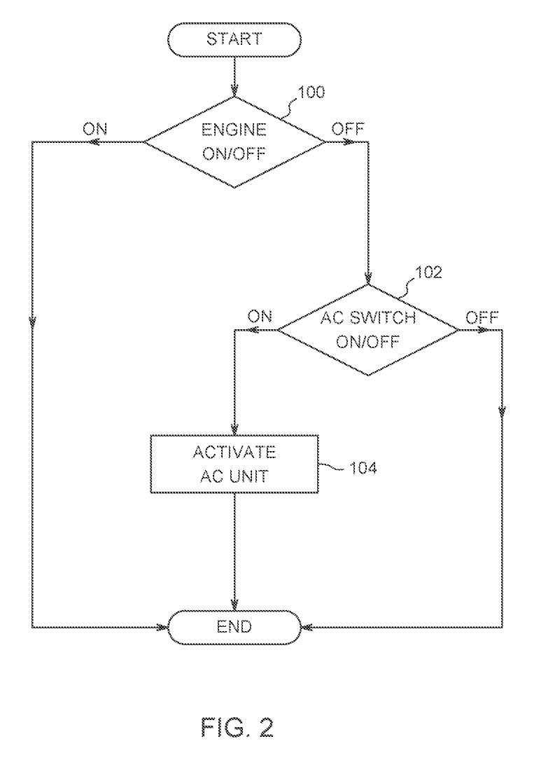

Referring to FIG. 2, another embodiment of the present invention comprises a method for controlling and maintaining the climate (i.e., the temperature) within an automobile when the engine thereof is turned off. The method initiates with an engine sensor determining (step 100) whether or not the engine is turned on. Upon determining that the engine is turned off, the method thereafter includes determining (step 102) whether or not an AC switch is turned on wherein, the AC switch corresponds to an auxiliary AC compressor (in addition to the onboard AC compressor of the automobile). The (auxiliary) compressor is adapted to be driven by a power motor, which is powered by an auxiliary battery (in addition to the regular onboard battery). The battery, which preferably is a 12-volt battery, is in turn is charged by a preferably 200 amp alternator when the automobile is back in motion. Notably, the battery and the alternator can be of any capacity and be well within the scope of the present invention. Notably, the AC switch is located at a place within the automobile that is readily accessible by the user. In one embodiment, the method further includes installing a cabin fan for circulating the output emanating from the blower.

Upon determining that the AC switch is turned on, the method thereafter leads to the next step of activating (step 104) the compressor. The method further includes activating the blower upon the activation of the compressor. Notably, the blower speed and the output temperature from the blower can configured to be adjustable by operating the onboard fan and temperature knobs respectively. The method further includes turning off the compressor in the event of the engine being turned on or in the event of the AC switch being turned off.

In one embodiment, the power motor is, in lieu of the compressor, disposed in operational communication with a plurality of utility devices onboard the automobile, which include a power steering pump, a water pump, a cooling fan, and a generator. Similar to the method of activation of the compressor, the utility devices are also configured to be activated in the similar manner. This embodiment of the present invention is especially useful for emergency vehicles, such as, ambulances, and the like.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. For example, the protective case assembly can be adapted to accommodate a tablet PC by simply altering the dimensions thereof. However, all such modifications are deemed to be within the scope of the claims.

What is claimed is:

1. A system for controlling the climate within an automobile when the engine thereof is turned off, the system comprising an auxiliary AC compressor disposed in fluid communication with the pre-existing AC lines of the automobile and an AC switch; the system configured such that, the compressor is activated upon the switch being turned on and upon the engine being turned off.

2. The system of claim 1 wherein, the compressor is driven by a power motor.

3. The system of claim 2 wherein, the power motor is powered by a battery.

4. The system of claim 3 wherein, the battery comprises a 12-volt battery.

5. The system of claim 3 wherein, the battery is charged by an alternator.

6. The system of claim 5 wherein, the alternator comprises a 200 amp alternator.

7. The system of claim 1, wherein the compressor is turned off upon the engine being turned on or the switch being turned off.

8. The system of claim 1 involving the onboard blower of the automobile such that, the blower is activated upon the activation of the compressor.

9. The system of claim 1 wherein, one of utility devices comprising a power steering pump, a water pump, a cooling fan, and a generator is configured to be used in lieu of the compressor; the utility devices powered by the power motor.

10. The system of claim 1 further comprising an engine sensor employed for determining whether the engine is turned on or off.

11. A method for controlling the climate within an automobile when the engine thereof is turned off, the method comprising:
(a) determining whether or not the engine is turned off;
(b) determining whether or not an AC switch is turned on in the event of the engine being turned off; and
(c) activating an auxiliary AC compressor upon determining that the switch is turned on upon the engine being turned off; the compressor disposed in fluid communication with the pre-existing AC lines of the automobile.

12. The method of claim 10 wherein, an engine sensor is employed for determining whether the engine is turned on or off.

13. The method of claim 10 further comprising deactivating the compressor upon determining that the engine is turned on or the switch is turned off.

14. The method of claim 10 wherein, the compressor is driven by a power motor.

15. The method of claim 13 wherein, the power motor is powered by a battery.

16. The method of claim 14 wherein, the battery comprises a 12-volt battery.

17. The method of claim 14 wherein, the battery is charged by an alternator.

18. The method of claim 16 wherein, the alternator comprises a 200 amp alternator.

19. The method of claim 10 further comprising: activating the onboard blower of the automobile upon the activation of the compressor.

20. The method of claim 10 wherein, one of utility devices comprising a power steering pump, a water pump, a cooling fan, and a generator is configured to be used in lieu of the compressor; the utility devices powered by the power motor.
